(19) United States
(12) Patent Application Publication
(10) Pub. No.: US 2006/0152206 A1
(43) Pub. Date: Jul. 13, 2006

(54) Method for improving the power supply rejection ratio (PSRR) of low power reference circuits

(76) Inventor: Tim Wen Hui Yu, Fremont, CA (US)

Correspondence Address: ADVANCED ANALOGIC TECHNOLOGIES, 830 EAST ARQUES AVE, SUNNYVALE, CA, 94085, US

(21) Appl. No.: 11/021,855

(22) Filed: Dec. 23, 2004

(51) Int. Cl. G05F 3/16; G05F 3/20

(52) U.S. Cl. 323/313

(57) ABSTRACT

A bandgap reference circuit includes two diode-connected transistors and an operational amplifier. The operational amplifier is connected in a feedback arrangement so that the current passing through transistor is substantially the same. This means that the current density in each transistor differs. The output of the operational amplifier is a function of the base emitter voltages of the two transistors and is substantially temperature invariant. Each transistor has a supplemental capacitor connected between its collector and emitter. The capacitors are substantially equal in size and both are substantially larger than the parasitic capacitance of either transistor. As a result, the overall capacitance of each transistor is substantially the same giving the reference circuit a favorable power supply rejection ratio.

### BACKGROUND OF THE INVENTION

Noise is a serious consideration for designers of analog circuits. Sources of noise include power supplies, couplings with other circuits and electromagnetic radiation from external sources. Noise and its effects on circuit performance are both hard to predict. In general, however the effects are undesirable. Low-power circuits are particularly vulnerable to noise. This results at least partially from the light biasing current found in low power circuits which limits the speed at which these circuits respond to noise.

Reference circuits are generally designed to provide voltage references that are independent of operating conditions such as power supply voltage, operation temperature, and fabrication process variations. Special care should also be paid in order make reference circuit performance independent of noise.

Bandgap reference circuits are a specific type of reference circuits. As shown in FIG. 1, a typical bandgap reference circuit includes two bipolar transistors. At steady state, the operational amplifier and resistor network supply an equal current to the two transistors. Each transistor has a different emitter area. As a result, the current density, and base-emitter voltage (V_{BE}) of the two transistors differ. The difference in base-emitter voltage (ΔV_{BE}) for the two transistors is a positive function of temperature. V_{BE}, on the other hand, is a negative function of temperature. By combining V_{BE} and ΔV_{BE}, the bandgap reference circuit is able to produce a reference voltage that is independent of temperature.

Unfortunately, the uneven size bipolar devices also make the bandgap reference circuit subject to performance degradation in noisy environments. This follows because the size difference between the two bipolar devices means that they have different parasitic capacitances. The difference in parasitic capacitances makes the transistors react differently to noise. This result of noise on a bandgap reference circuit is shown, for example by the waveform of FIG. 2.

One common method for improving the performance of bandgap reference circuits is to add a redundant transistor. An example of this is shown in FIG. 3. The redundant transistor Q3 which has the area of Q2−Q1 is added to the source of Q1. The idea is to match the parasitic capacitance at the emitters of Q1 and Q2 by adding redundant device Q3. Although generally an effective method for improving the power supply rejection ration (PSRR) of reference circuits, the redundant components are costly in terms of silicon area and don't behave as the active devices (C1≠C2). The PSRR improvement is limited. This is shown, for example in FIG. 3.

### SUMMARY OF THE INVENTION

The present invention includes a bandgap reference circuit with improved power supply rejection ratio. A typical implementation of the bandgap reference circuit includes an operational amplifier and two bipolar transistors. The transistors are unevenly sized—with the larger typically being in the range of 8 to 24 times larger than the smaller transistor. The operational amplifier produces a voltage V_{BG}. A resistor R1 connects the emitter of the smaller transistor to the voltage V_{BG}. A series connection of two resistors R₂ and R_{PTAT} connects the emitter of the larger transistor to the voltage V_{BG}. The operational amplifier is connected so that one input monitors the voltage at the emitter of the smaller transistor and the other input monitors the voltage between R₂ and R_{PTAT}.

Two capacitors are connected, one between the collector and emitter of each transistor. The capacitors are chosen to have approximately equal capacitance with each being larger than the parasitic capacitance of the two transistors. By correctly choosing the size of the two capacitors, each of the two transistors is made to appear to have the same (or nearly the same) capacitance. In this way, the bandgap reference circuit has a significantly improved power supply rejection ratio.

### BRIEF DESCRIPTION OF THE DRAWINGS

FIG. 1 is a block diagram of a prior art bandgap reference circuit.

FIG. 2 is a waveform for the circuit of FIG. 1.

FIG. 3 is a block diagram of a prior art bandgap reference circuit with supplemental transistor.

FIG. 4 is a waveform for the circuit of FIG. 3.

FIG. 5 is a block diagram of a bandgap reference circuit as provided by an embodiment of the present invention.

FIG. 6 is a waveform for the circuit of FIG. 5.

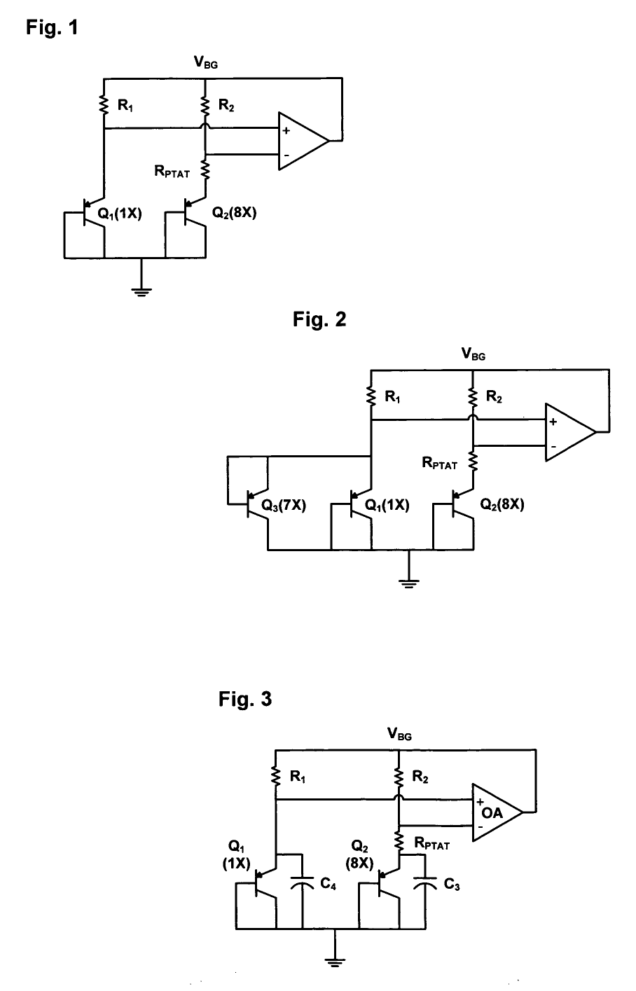

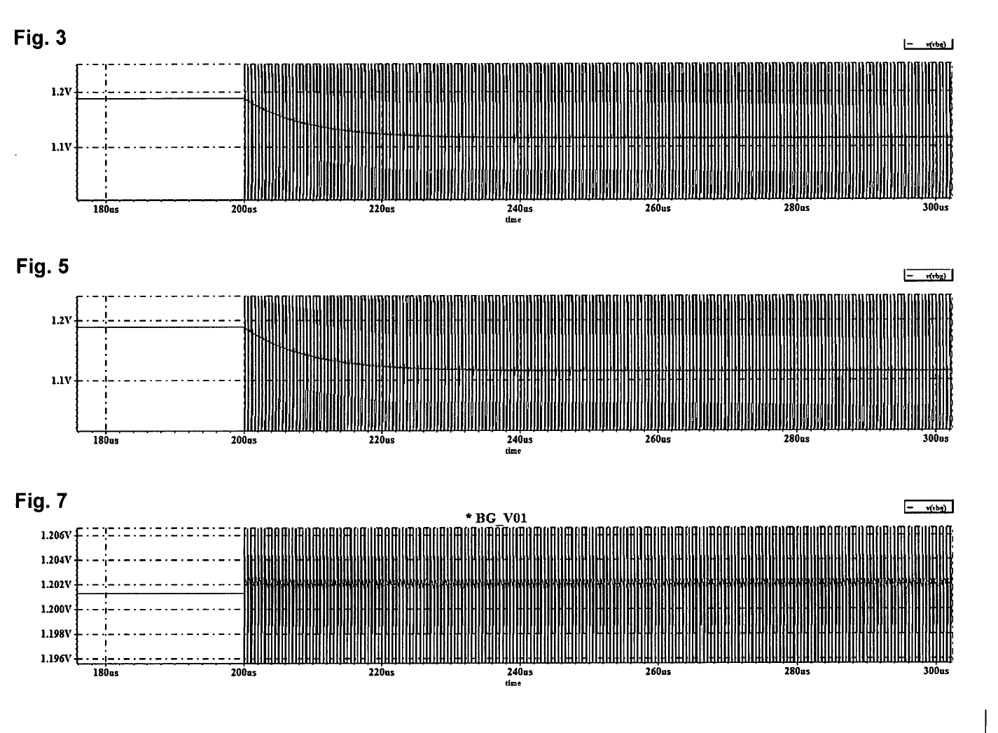

### DETAILED DESCRIPTION OF THE PREFERRED EMBODIMENTS

The present invention includes a bandgap reference circuit with improved power supply rejection ratio. As shown in FIG. 5, a typical implementation of the bandgap reference circuit includes an operational amplifier OA and two bipolar transistors Q₁ and Q₂. The transistors Q₁ and Q₂ are unevenly sized with Q₂ typically being 8 to 24 times larger than Q₁. Both Q₁ and Q₂ are diode-connected creating P-N junctions between the emitters and bases of the two transistors.

The operational amplifier produces an output voltage V_{BG} that functions as the output voltage of the bandgap reference circuit. A resistor R1 is connected between the emitter of the transistor Q₁ and the voltage V_{BG}. Similarly, a series of two resistors resistor R₂ and R_{PTAT} is connected between the emitter of the transistor Q₂ and the voltage V_{BG}. The two sets of resistors (R₁ and the series of R₂ and R_{PTAT} form two feedback loops. The operational amplifier is connected to both loops with one input monitoring the voltage at the emitter of the Q₁ and the other monitoring the voltage between R₂ and R_{PTAT}.

Capacitor C₁ is connected between the collector and emitter of transistor Q₁. Capacitor C₂ is likewise connected between the collector and emitter of transistor Q₂. The capacitors C₁ and C₂ are selected to have approximately equal capacitance. C₁ and C₂ are also selected to be larger than the parasitic capacitance of the two transistors Q₁ and Q₂. By correctly choosing the size of the two capacitors, each of the two transistors is made to appear to have the same (or nearly the same) capacitance. Thus, if PC₁ is the parasitic capacitance of Q₁ and PC₂ is the parasitic capacitance of Q₂ it follows that the combination of C₁+PC₁ becomes increasing equivalent to C₂+PC₂ as C₁ and C₂ grow in relation to PC₁ and PC₂. The matching capacitance of transistors Q₁ and Q₂ gives the bandgap reference circuit of FIG. 5 a significantly improved power supply rejection ratio when compared to conventional designs.

In steady state operation, the operational amplifier causes the voltage between R₂ and R_{PTAT} to equal the voltage at the emitter of Q₁. For the case where R₁ equals R₂, this means that an equal current flows through the transistors Q₁ and Q₂. The unequal emitter areas of Q₁ and Q₂ mean that the base emitter voltage (V_{BE}) for Q₂ is smaller than the V_{BE} for Q₁. The difference (i.e., Q₁ minus Q₂) is referred to as ΔV_{BE} and appears over the resistor R_{PTAT}. The output of the bandgap reference circuit may then be expressed as:
V_{BG}=V_{BE}+(1+R₂/R_{PTAT})ΔV_{BE}
where: ΔV_{BE}=V_{T}ln(N)=(kT/q)ln(N), k is Boltzman's constant, T is temperature in degrees Kelvin and q is the charge of an electron. The two terms that make up V_{BG} differ in their dependence on temperature. V_{BE} has a negative temperature coefficient while ΔV_{BE} has a positive temperature coefficient. Proper selection of R₂ and R_{PTAT} allows the combination to be substantially invariant of temperature.

What is claimed is:

1. A reference circuit that comprises:
a diode-connected first transistor and a diode-connected second transistor, where the first transistor has an emitter area that is larger than the emitter area of the second transistor;
a resistor R_{PTAT} connected to the emitter of the second transistor;
an operational amplifier having a first input connected to the emitter of the first transistor, and a second input connected to the resistor R_{PTAT}, the operational amplifier producing an output that is a function of the difference between the base emitter voltage of the first transistor and the base emitter voltage of the second transistor; and
a first capacitor connected between the emitter and collector of the first transistor and a second capacitor connected between the emitter and collector of the second transistor where the first and second capacitors are selected so that the combination of first transistor and first capacitor have a combined capacitance that is substantially equal to the combination of the second transistor and second capacitor.

2. A circuit as recited in claim 1 that further comprises:
a resistor R₁ connected between the emitter of the first transistor and the output of the operational amplifier; and
a resistor R₂ connected between the input and output of the operational amplifier.

3. A circuit as recited in claim 1 where the first transistor has an emitter area that is eight to twenty-four times larger than the emitter area of the second transistor.

4. A reference circuit that comprises:
a first transistor and a second transistor, where the first transistor has an emitter area that is larger than the emitter area of the second transistor;
a resistor R_{PTAT} connected to the emitter of the second transistor;
an operational amplifier having a first input connected to the emitter of the first transistor, and a second input connected to the resistor RPTAT;
a first capacitor connected between the emitter and collector of the first transistor and a second capacitor connected between the emitter and collector of the second transistor.

5. A circuit as recited in claim 4 where the first and second capacitors are selected so that the combination of first transistor and first capacitor have a combined capacitance that is substantially equal to the combination of the second transistor and second capacitor.

6. A circuit as recited in claim 4 that further comprises:
a resistor R₁ connected between the emitter of the first transistor and the output of the operational amplifier; and
a resistor R₂ connected between the input and output of the operational amplifier.

7. A circuit as recited in claim 4 where the first transistor has an emitter area that is eight to twenty-four times larger than the emitter area of the second transistor.
